(19) United States
(12) Patent Application Publication
(10) Pub. No.: US 2010/0227243 A1
(43) Pub. Date: Sep. 9, 2010

(54) FUEL CELL STACK WITH METAL SEPARATORS

(75) Inventors: SHIQAH-PING JUNG, Taoyuan County (TW); HUAN-RUEI SHIU, Penghu County (TW); CHI-CHANG CHEN, Changhua County (TW); KUI-HAN CHEN, Taichung County (TW); SSU-TAI LIN, Nantou County (TW); WEN-CHEN CHANG, Hsin-Chu (TW); FANGHEI TSAU, Kaohsiung County (TW)

Correspondence Address: WPAT, PC;INTELLECTUAL PROPERTY ATTORNEYS, 7225 BEVERLY ST., ANNANDALE, VA, 22003, US

(73) Assignee: Industrial Technology Research Institute, Hsin-Chu (TW)

(21) Appl. No.: 12/509,108

(22) Filed: Jul. 24, 2009

(30) Foreign Application Priority Data
Mar. 5, 2009 (TW) 098107073

(51) Int. Cl. H01M 8/04; H01M 4/82

(52) U.S. Cl. 429/458; 29/623.1; 429/459

(57) ABSTRACT

A single cell structure used in a fuel cell stack with metal separators, the single cell structure comprising: a cathode gas diffusion layer; an anode gas diffusion layer; a membrane electrode assembly, disposed between the cathode gas diffusion layer and the anode gas diffusion layer; a pair of first separators disposed outside the cathode gas diffusion layer and the anode gas diffusion layer, a first surface of the first separators being provided with a plurality of grooves and ribs thereon; a pair of second separators disposed outside the first separators to be assembled with the first separators, a first surface of the second separators being provided with a plurality of groove and ribs; and a pair of middle separators disposed outside the second separators to be assembled with the second separators.

### FIELD OF THE INVENTION

The present invention generally relates to a fuel cell stack and, more particularly, to a fuel cell stack with metal separators.

### BACKGROUND OF THE INVENTION

Natural resources have been the motivating force for humans to live and become civilized. However, with the nonstop consumption on oil and gas, humans realize these resources will be used up sooner or later. Moreover, the use of fossil fuels also brings forth ecological problems such as the green house effect. With the awakening of environmental consciousness, the research and development on the fuel cell has attracted tremendous amount of attention. Especially, the proton exchange membrane (PEM) fuel cell exhibits high efficiency, low pollution, low noise and low-temperature characteristic, which make it widely used as a portable power supply, a stationary power generator and a power provider for vehicles.

Generally, the required cell lifetime depends on actual demands. For example, the design of a backup power generation system is not limited by space. Instead, the designed backup power generation system has to meet the requirement for long time operation. Therefore, the fuel cell uses anti-corrosion carbon plates as the bipolar plates. However, the car-use power supply uses high power density fuel cell due to the limitation of space and low requirement for lifetime. Therefore, separators made of metal plates have become inevitable to achieve high power density. The currently used metal plates are mostly stainless steel, which can be manufactured by stamping for mass production to effectively reduce the thickness and weight of the metal plates. Accordingly, the size of the fuel cell can be significantly reduced while the power density can be enhanced. To further improve anti-corrosion of the metal plates, surface treatment is required to lengthen the lifetime of the fuel cell.

Please refer to FIG. 1, which is a schematic structure of a proton exchange membrane (PEM) fuel cell. The fuel cell stack 1 comprises a plurality of single cell structures, each comprising a membrane electrode assembly 2 for electrochemical reaction and transport of electrons and protons. A cathode gas diffusion layer 3 and an anode gas diffusion layer 4 are provided on both sides of the membrane electrode assembly 2. Reaction gas in the flow path diffuses to electrodes through the two gas diffusion layers. Outside the gas diffusion layers 3 and 4, there are provided a cathode separator 7 and an anode separator 8, whereon a plurality of flow paths are formed for reaction gas distribution. The separators are provided with ribs to support the gas diffusion layers and the membrane electrode assembly and to conduct heat and electricity. Sealing structures 5 and 6 are disposed between the two separators (7, 8) and the two gas diffusion layers (3, 4) to prevent the reaction gas and the coolant from leaking or crossing over. The cathode current collector 9 and the anode current collector 10 are capable of collecting currents. External circuitry is used as a circulating current path for the fuel cell. The end plates 11 and 12 are used to fix the fuel cell stack by applying a force to compress the fuel cell stack to a proper height. The end plates also function as supply manifolds and discharge manifolds for the reaction gas and coolant.

The aforesaid fuel cell structure uses carbon plate or metal plates as the separators. However, the metal plates are generally manufactured by stamping, which are quite different from carbon plates manufactured by CNC machining, hot embossing or injection molding. Therefore, the flow field designs using the metal plates and the carbon plates can be different so that the sealing structures are disposed differently. Please refer to FIG. 2, which is a cross-sectional diagram of a separator. The separator is implemented as a carbon plate separator 13 or a metal separator 17. For the carbon plate separator 13, the gas flow path 14 and the coolant flow path 15 may have different types and sizes of flow fields, wherein there is a rib 16 provided between two flow paths. For the metal separator 17, there are gas flow paths 18 and coolant flow paths 19 formed by stamping on both sides of a metal plate. Each flow path 18 on one side of the metal plate corresponds to one rib 20. To manufacture the gas flow paths 18 and the coolant flow paths by stamping at the same time, the metal separator 17 is generally designed to provide straight flow paths. On the other hand, the carbon plate separator 13 provides diverse flow field designs as the gas flow paths 14 and the coolant flow paths 15, for example, serpentine-shaped gas flow paths and straight coolant flow paths. The flow paths on the metal plate separator 17 are more restricted than those on the carbon plate separator 13. Therefore, it is possible that some flow field designs that are more suitable for the certain system cannot be used.

For a fuel cell stack using metal separators, the high power density characteristics make it suitable for use in the vehicles. Car manufacturers such as Mercedes Benz, General Motors (GM), Honda and Toyota have started to develop such a device and applications thereof. For example, fuel cells using metal separators are disclosed in, for example, U.S. Pat. No. 6,872,483 B2, U.S. Pat. No. 7,018,733 B2, U.S. Pat. No. 7,195,837 B2, and U.S. Pat. No. 7,396,609 B2 filed by Honda in 2005 to 2008. U.S. Pat. No. 6,974,648 B2, U.S. Pat. No. 7,291,414 B2, and U.S. Pat. No. 7,318,973 B2 are filed by GM in 2005, 2007 and 2008, respectively.

In the present invention, however, a fuel cell stack with metal separators manufactured by stamping is disclosed. Therefore, the present invention is different from those prior arts using carbon plate separators or metal plate separators by non-stamping, and thus descriptions of the latter are not presented herein.

Please refer to FIG. 4, wherein U.S. Pat. No. 6,872,483 B2 discloses metal separators used in a fuel cell. The metal separators are provided with grooves and ribs being alternate thereon. A flexible thin plate is disposed between two metal separators to support the ribs on the separators so that each of the grooves on one separator corresponds to a rib on another separator across the flexible thin plate. Thereby, fuel and oxygen-containing gas are capable of flowing in the grooves on the separators. The grooves between the flexible thin plate and the separators are used as coolant flow paths.

Please refer to FIG. 5, wherein U.S. Pat. No. 7,018,733 B2 discloses a fuel cell module with metal separators. The metal separators comprise a first separator, a second separator and a middle separator. An oxygen-containing gas flow path is disposed on one side of the first separator and the cathode. A fuel gas flow path is disposed on one side of the second separator and the anode. A coolant flow path is disposed between the middle separator and the first and second separators. Therefore, the coolant can flow on both sides of the middle separator. The middle separator is provided with heat insulation so as to prevent heat exchange between both sides of the middle separator.

Please refer to FIG. 6, wherein U.S. Pat. No. 7,195,837 B2 discloses metal separators with hollow zigzag ribs. With a combination of the separator and the cathode or the anode, flow paths for fuel and oxygen-containing gas are formed in the hollow zigzag ribs. Moreover, since the hollow ribs on two separators contact each other, a coolant flow path is formed between the two separators.

Please refer to FIG. 7, wherein U.S. Pat. No. 7,396,609 B2 discloses the sealing of metal separators of a fuel cell. The separator is provided with a planar surface in addition to grooves and ribs. The sealing element is disposed on the planar surface so that the gas and the coolant can be sealed and flow inside the separators.

Please refer to FIG. 8, wherein U.S. Pat. No. 6,974,648 B2 discloses metal separators of a fuel cell. The metal separators comprise a first separator whereon the fuel gas flows; and a second separator whereon the oxygen-containing gas flows. The first and the second separators are combined as a nest so that a coolant flow path is formed therein. For this purpose, the width of the ribs on the first and the second separators has to be larger than the width of the grooves on the first and the second separators.

Please refer to FIG. 9, wherein U.S. Pat. No. 7,291,414 B2 discloses the supply of gas and coolant on the metal separators. The metal separators comprise a gas feed region channeled with cathode and anode flow paths in the reaction area. The metal separators also comprise a coolant feed region channeled with coolant flow paths in the reaction area. The separators may be nest-shaped or non-nest-shaped.

Please refer to FIG. 10, wherein U.S. Pat. No. 7,318,973 B2 discloses metal separators with serpentine-shaped flow paths being mirror-symmetric. With the combination of the two separators, a serpentine-shaped flow path is formed between the two separators. To form the flow paths for the reaction gas and the coolant, two different bridge members are used to guide the fuel and the oxygen-containing gas into the serpentine-shaped flow path in the anode reaction area, the serpentine-shaped flow path in the cathode reaction area and the serpentine-shaped flow path in the cooling zone, respectively.

In the aforesaid prior arts, U.S. Pat. No. 6,872,483 B2, U.S. Pat. No. 7,195,837 B2 and U.S. Pat. No. 6,974,648 B2 disclose metal separators comprising straight flow paths. U.S. Pat. No. 7,318,973 B2 discloses metal separators comprising serpentine-shaped flow paths being mirror-symmetric. U.S. Pat. No. 7,018,733 B2 and U.S. Pat. No. 7,291,414 B2 disclose a flow field on the metal separators. U.S. Pat. No. 7,396,609 B2 discloses a sealing structure for metal separators. Therefore, the present invention is different from the prior arts in:

1. Metal separators: In the present invention, the flow paths on the metal separators can be straight, serpentine-shaped or any other flexibly designed flow field. With such flow field design, requirements of the flow rate, the pressure drop and water-thermal management features can be met for different operating conditions to achieve optimal performance of the fuel cell stack.

2. Sealing structure: The sealing of the present invention is different from the prior arts to seal between the metal separators or between the separator and other components to prevent the gas and the coolant from leaking or crossing over to achieve stable and high-efficiency operation of the fuel cell stack.

3. Assembling process: The single cell structure of the present invention is formed in a different way from the prior arts. In the single cell structure, flow paths for the fuel gas, the oxygen-containing gas and the coolant are provided. When a plurality of single cell structures are stacked as a fuel cell stack, a flow field is generated for the fuel gas, the oxygen-containing gas and the coolant. With the use of end plates, an attachment force is applied to compress the fuel cell stack so that the components therein, such as the gas diffusion layer and the membrane electrode assembly, are compressed and effective sealing is achieved.

### SUMMARY OF THE INVENTION

In view of the foregoing drawbacks, the present invention provides a high power density PEM fuel cell stack with metal separators. To achieve high power density per volume or weight, metal plates manufactured by stamping are used as separators. The separators are provided with flow paths for the reaction gas and the coolant. Moreover, the metal separators are combined so that the flow field can be straight, serpentine-shaped or any other flexibly designed flow field. With such flow field design, requirements of the flow rate, the pressure drop and water-thermal management features can be met for different operating conditions to achieve optimal performance of the fuel cell stack.

The present invention further provides a fuel cell stack with metal separators. The sealing of the present invention is capable of preventing the gas and the coolant from leaking or crossing over to achieve stable and high-efficiency operation of the fuel cell stack. Therefore, a sealing structure is provided in the present invention. For the metal separators and the sealing structure, an assembling process is required to combine the components therein, such as the gas diffusion layer and the membrane electrode assembly, to form a single cell structure. A plurality of single cell structures are stacked to form a fuel cell stack.

The present invention further provides a fuel cell stack with metal separators. The first separator and the second separator have the same structure, and therefore the separators can be used for a flow field for the reaction gas and the coolant.

The present invention further provides a fuel cell stack with metal separators. The metal separators are combined so that the flow field can be straight, serpentine-shaped or any other flexibly designed flow field.

In one embodiment, the present invention provides a fuel cell stack with metal separators, using metal plates as separators for the PEM fuel cell. With the use of a sealing structure, a single cell structure is formed. A plurality of single cell structures are stacked to form a fuel cell stack. To operate the fuel cell stack at high efficiency, all the components are required to provide functionalities. Therefore, the separator, the sealing structure and the assembling process are described herein:

1. Separators: The separators provide several functions in a fuel cell. Firstly, the separators guide the reaction gas and the coolant from the supply manifolds into the flow paths. Secondly, the separators uniformly distribute the reaction gas and the coolant over the reaction area by way of the flow paths thereon. Thirdly, the separators guide the residues such as unreacted gas, production water and the coolant into the discharge manifold by way of the flow paths. Fourthly, the ribs on the separators are capable of conducting heat and electricity. Accordingly, firstly, the reaction gas and the coolant are guided by manifolds to be uniformly distributed over each of the single cell structures. Secondly, the flow paths are capable of uniformly distributing the reaction gas over the reaction area to make sure that the concentration of the reaction gas is sufficient. The liquid water produced by the electrochemical reaction has to be effectively discharged. The flow paths are capable of uniformly distributing the coolant over the reaction area to remove the heat generated by the cell during power generation to prevent the cell performance from being affected or prevent the components from being damaged. Thirdly, the unreacted gas, the produced liquid water and the coolant are discharged from the fuel cell stack by way of the discharge manifold to discharge the low concentration reaction gas, produced liquid water and the waste heat. Fourthly, the ribs on the separators are capable of conducting heat and electricity. The current paths formed by the ribs are capable of enabling the electrons to leave the anode catalyst layer and enter the cathode catalyst layer to complete electrochemical oxidation-reduction reaction. The ribs also conduct heat so that waste heat generated due to power generation can be conducted into the coolant to stabilize the cell temperature.

2. Sealing structure: The sealing structure of the present invention prevents the gas and the coolant from leaking into the environment and prevent cross-over between the reaction gases or between the reaction gas and the coolant. If the reaction gas or the coolant leaks, the cell performances may degrade and hazards may happen. If cross-over occurs, the direct reaction between hydrogen and oxygen may cause cell performances to degrade and even damage the fuel cell stack. Therefore, the sealing structure is one of the key factors for stable performances and the duration of the fuel cell.

3. Assembling process: To form a fuel cell stack using a plurality of single cell structures, the separators, the sealing structure and other components, such as the gas diffusion layers and the membrane electrode assembly, have to be combined in order. Generally, the single cell structure is formed by combining the separator, the sealing structure, the gas diffusion layer, the membrane electrode assembly, the gas diffusion layer, the sealing structure and the separator. A fuel cell stack is formed by stacking a plurality of single cell structures in order until the required power is achieved. To have the fuel cell stack fixedly after it is formed, end plates are required to clip with a sufficient force to compress the fuel cell stack so that the ribs make all the components contact each other and that the sealing structure is capable of seal the fuel cell stack to prevent leakage and cross-over of the reaction gas and the coolant.

### BRIEF DESCRIPTION OF THE DRAWINGS

The objects and spirits of various embodiments of the present invention will be readily understood by the accompanying drawings and detailed descriptions, wherein:

FIG. 1 is a schematic structure of a proton exchange membrane (PEM) fuel cell;

FIG. 2 is a cross-sectional diagram of a separator;

FIG. 3 is a schematic diagram of a single cell structure according to the present invention;

FIG. 4 shows a disclosure in U.S. Pat. No. 6,872,483 B2;

FIG. 5 shows a disclosure in U.S. Pat. No. 7,018,733 B2;

FIG. 6 shows a disclosure in U.S. Pat. No. 7,195,837 B2;

FIG. 7 shows a disclosure in U.S. Pat. No. 7,396,609 B2;

FIG. 8 shows a disclosure in U.S. Pat. No. 6,974,648 B2;

FIG. 9 shows a disclosure in U.S. Pat. No. 7,291,414 B2;

FIG. 10 shows a disclosure in U.S. Pat. No. 7,318,973 B2;

FIG. 11A is a 3-D diagram of a first separator according to the present invention;

FIG. 11B is a cross-sectional diagram of FIG. 11A;

FIG. 12A is a 3-D diagram of a second separator according to the present invention;

FIG. 12B is a cross-sectional diagram of FIG. 12A;

FIG. 13 is a 3-D diagram of a middle separator according to the present invention;

FIG. 14 is a combinational schematic diagram of a membrane electrode assembly sealing member and a first separator according to the present invention;

FIG. 15 is a combinational schematic diagram of a coolant sealing member and a second separator according to the present invention;

FIG. 16A is a combinational schematic diagram of a separator sealing member and a first separator according to the present invention;

FIG. 16B is a combinational schematic diagram of a separator sealing member and a second separator according to the present invention;

FIG. 17 is an exploded view of a single cell structure according to the present invention;

FIG. 18 shows a flow field through a single cell structure according to the present invention; and

FIG. 19 is a schematic diagram of a fuel cell stack according to the present invention.

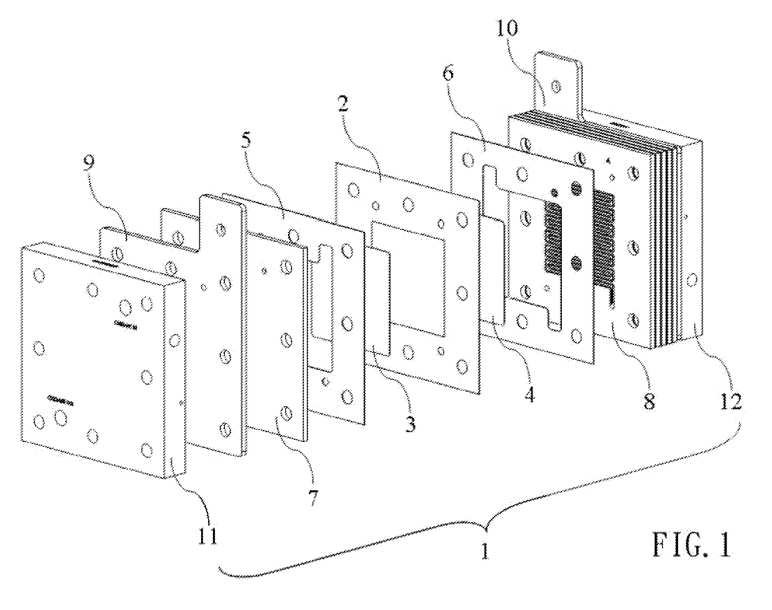

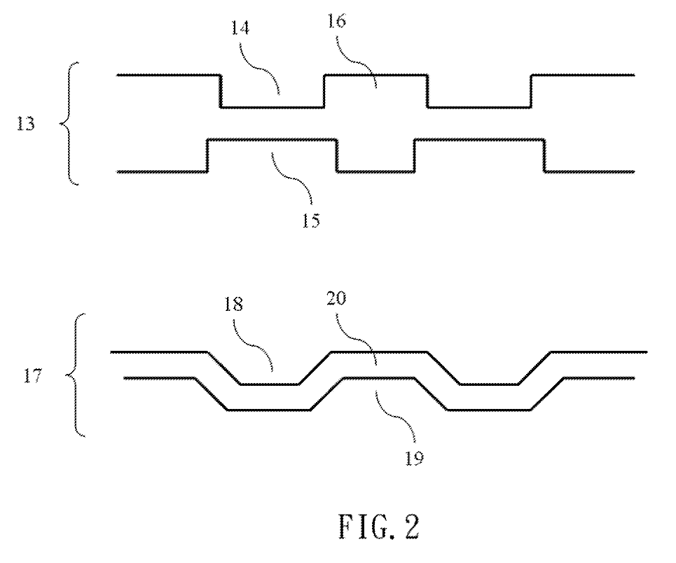

### DETAILED DESCRIPTION OF THE PREFERRED EMBODIMENT

The present invention can be exemplified by but not limited to various embodiments as described hereinafter.

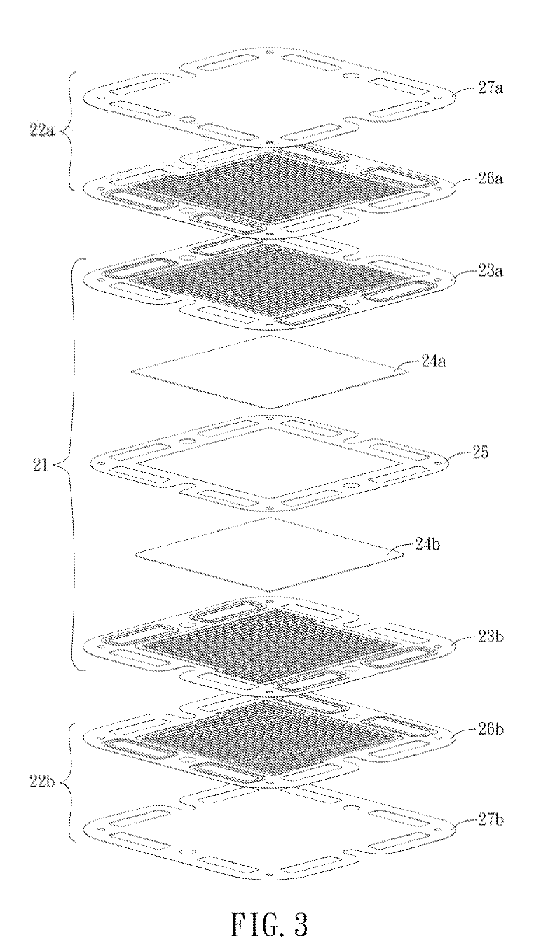

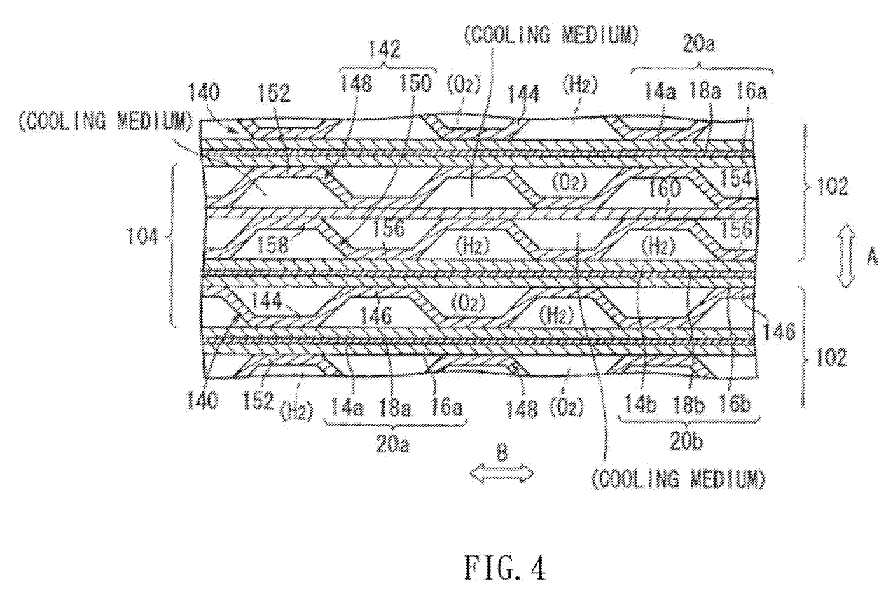

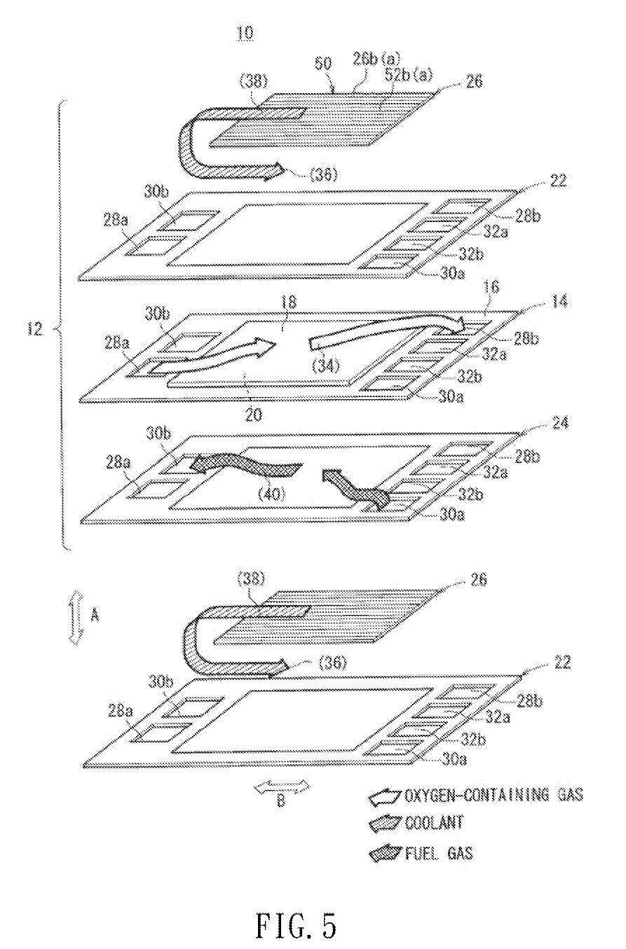

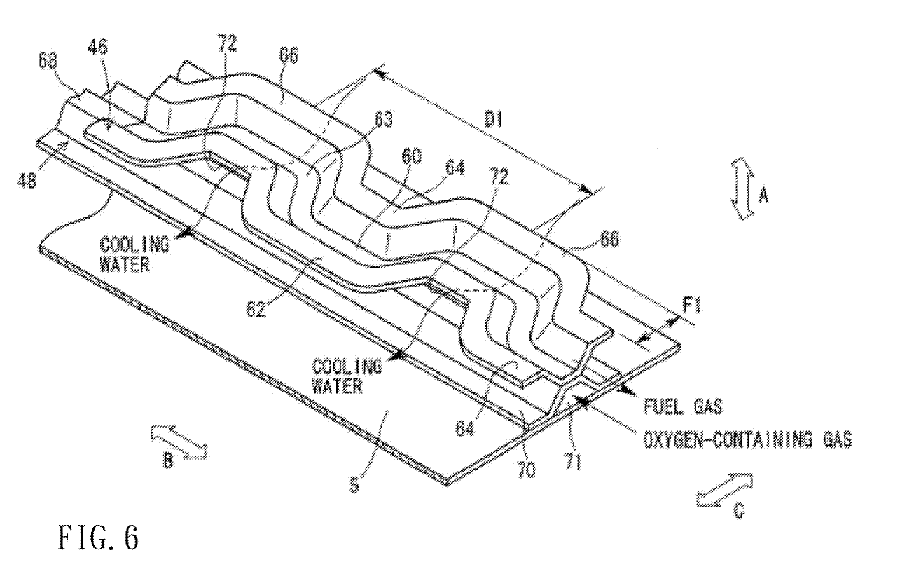

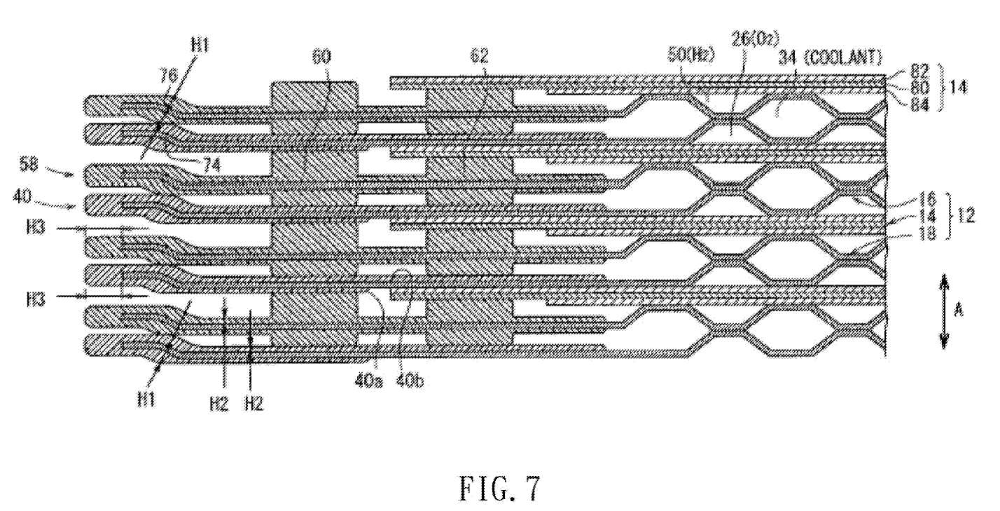

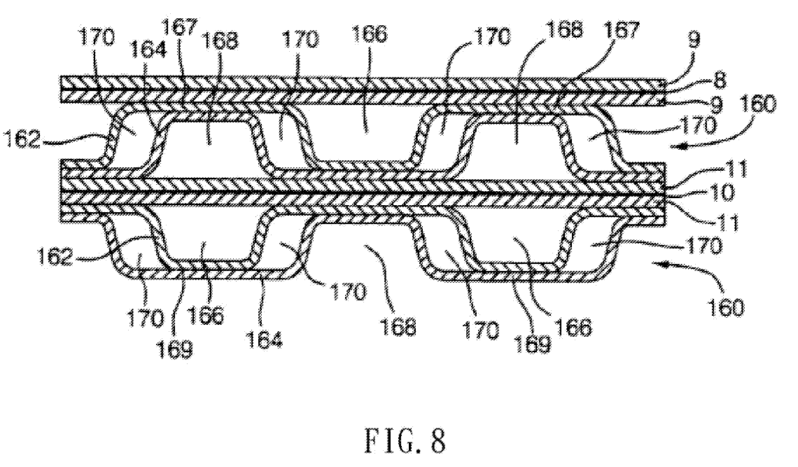

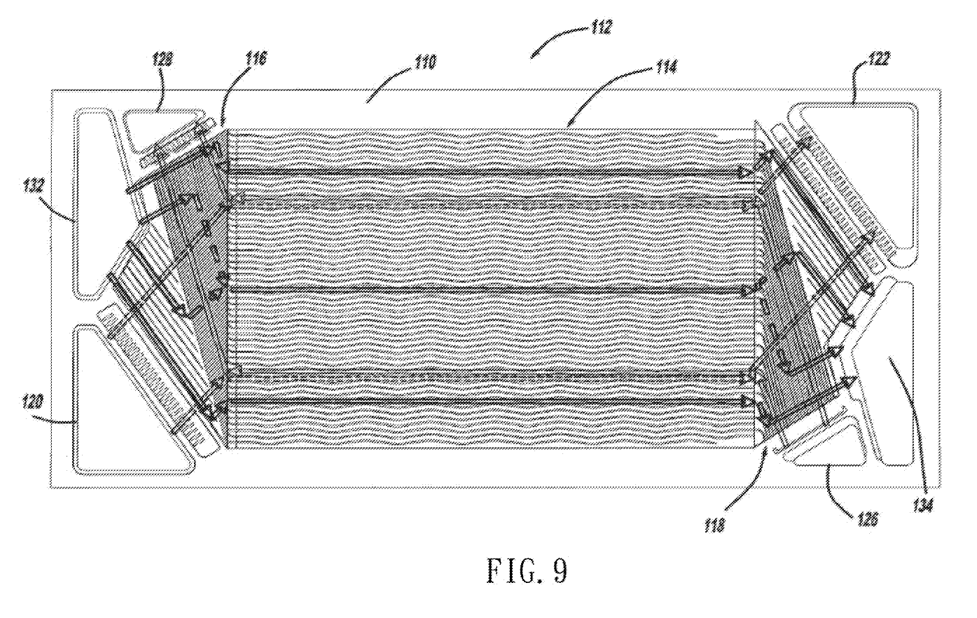

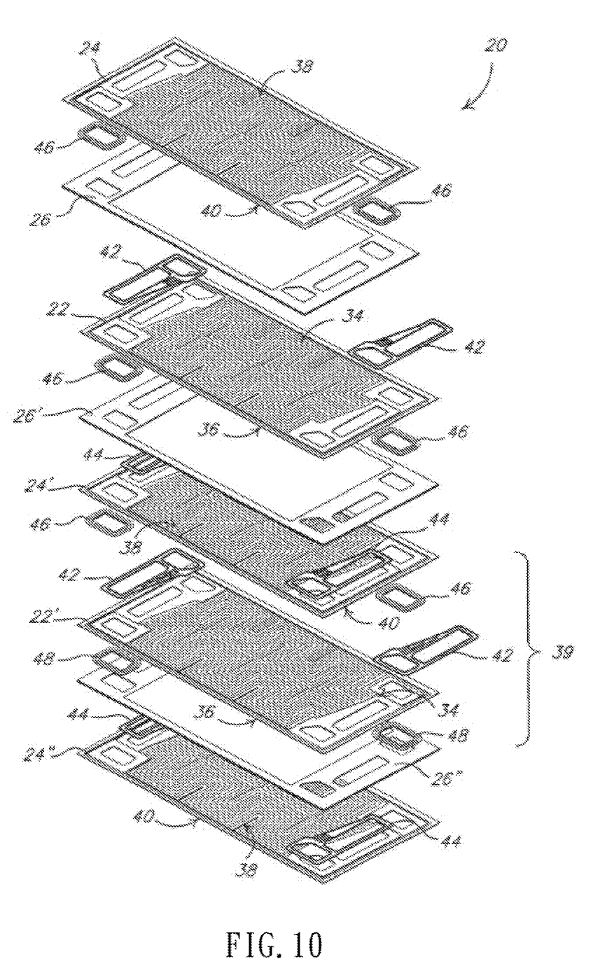

Please refer to FIG. 3, which is a schematic diagram of a single cell structure according to the present invention. The electrochemical reaction region 21 comprises a first cathode separator 23a, a first anode separator 23b, a cathode gas diffusion layer 24a, an anode gas diffusion layer 24b, and a membrane electrode assembly 25. On the first separators 23a and 23b are provided with ribs formed by stamping. With the gas diffusion layers tightly contacting the ribs on the metal separators as well as the sealing structure, the grooves formed by stamping are used as flow paths for the oxygen-containing gas on the cathode side and the fuel gas on the anode side. The coolant flow zones 22a and 22b are respectively formed by the second separators 26a and 26b, and the middle separators 27a and 27b. On the second separators 26a and 26b are provided with ribs formed by stamping. The middle separators 27a and 27b are metal plates with a planar surface. With the ribs on the second separators tightly contacting the planar surface of the middle separators as well as the sealing structure, the grooves formed by stamping are used as flow paths for the coolant.

The first separators 23a, 23b and the second separators 26a and 26b have the same structure. When being used in different zones, the cooling separator is formed by rotating the first separator by 90 degrees clockwise with respect to a central axis on the first surface of the first separator. Alternatively, the gas separator is formed by rotating the second separator by 90 degrees clockwise with respect to a central axis on the first surface of the second separator. With such an arrangement, the metal separator can be used as a gas separator and a cooling separator. Moreover, the flow paths by stamping are not limited to being straight. Instead, the flow paths can be of any shape according to the systems' demand. Accordingly, in order to make the metal separator used as a gas separator and a cooling separator, an assembling process is required to combine the metal separators, the aforesaid metal plates and other components to form a single cell structure to further form a fuel cell stack.

In the present invention, three topics including the metal separators, the sealing structure and the assembling process are important to implement the fuel cell stack.

### Metal Separators:

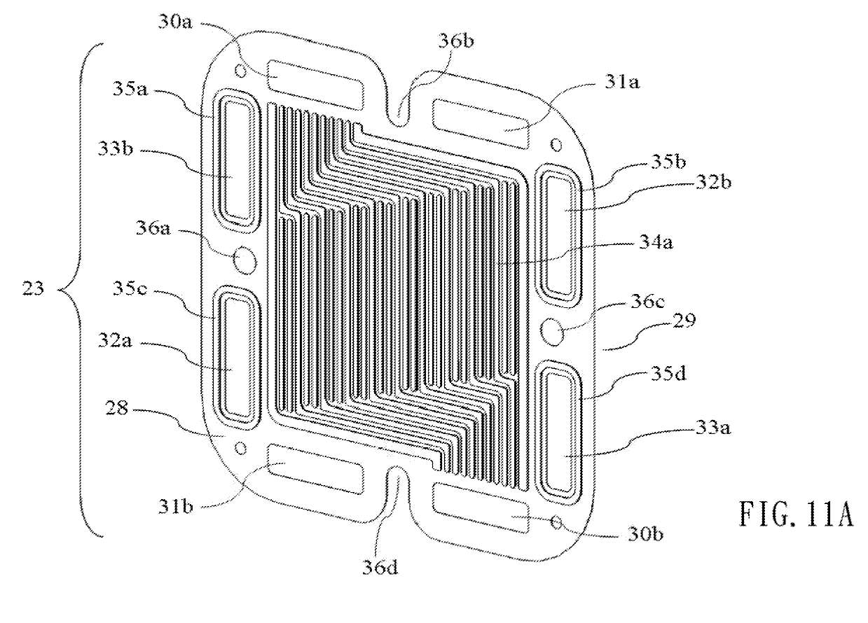

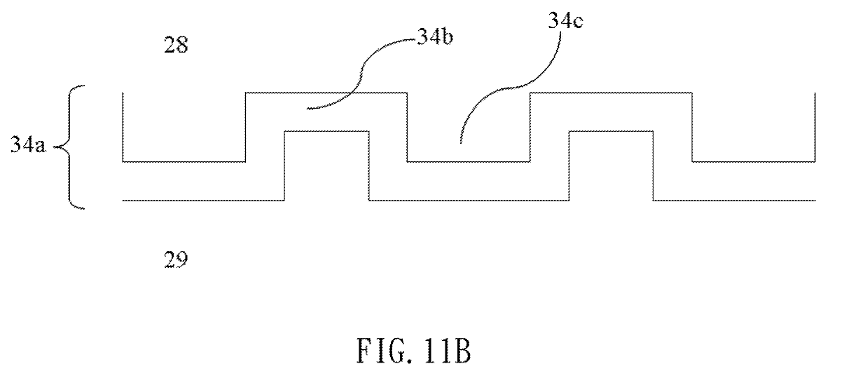

The metal separators of the present invention comprise a first separator, a second separator and a middle separator, as shown in FIG. 11 to FIG. 13. The first separator and the second separator have the same separator structure with ribs and grooves by stamping. The middle separator is a metal plate with a planar surface. The first separator, the second separator and the middle separator are described in detailed herein.

### 1. First Separator:

FIG. 11A and FIG. 11B show a 3-D diagram and a cross-sectional diagram of a first separator according to the present invention. The first separator 23 has a first surface 28 and a second surface 29 opposite to the first surface. When the first surface 28 faces the cathode, the first separator 23 is used as a cathode separator being capable of distributing oxygen-containing gas. When the first surface 28 faces the anode, the first separator 23 is used as an anode separator being capable of distributing fuel gas. Manifolds 30a, 30b, 31a and 31b penetrate the first separator 23. When the first separator 23 is used as a cathode separator, the manifolds 30a and 30b are used as an oxygen-containing gas supply manifold and an oxygen-containing gas discharge manifold, respectively, while the manifolds 31a and 31b are used as a fuel gas supply manifold and a fuel gas discharge manifold, respectively. When the first separator 23 is used as an anode separator, the manifolds 30a and 30b are used as a fuel gas supply manifold and a fuel gas discharge manifold, respectively, while the manifolds 31a and 31b are used as an oxygen-containing gas supply manifold and an oxygen-containing gas discharge manifold, respectively.

Similarly, manifolds 32a, 32b, 33a and 33b penetrate the first separator 23. Manifolds 32a and 33a are used as coolant supply manifolds, while manifolds 32b and 33b are used as coolant discharge manifolds. The reaction gas flow path 34a comprises alternate ribs 34b and grooves 34c manufactured by stamping. The ribs 34b and the grooves 34c are disposed on the first surface 28 of the first separator 23. The ribs 34b are capable of transferring a force to the other components of the fuel cell stack so that the fuel cell stack can be properly compresses and are capable of conducting heat and electricity. The grooves 34c are used as fuel gas flow paths on the anode separator or oxygen-containing gas flow paths on the cathode separator. Even though in the present embodiment the reaction gas flow paths are zigzag flow paths, it can also be straight or serpentine-shaped. The ribs 35a, 35b, 35c and 35d are formed on the first surface 28 of the first separator 23 and the grooves formed on the second surface 29 correspond to the ribs. With the use of a sealing structure, the first separator and the second separator may be combined to achieve effective sealing.

The manifolds 30a and 31b and the manifolds 31a and 30b on the first separator 23 are mirror-symmetric, while the manifolds 32a and 33b and the manifolds 33a and 32b are also mirror-symmetric. Accordingly, when the first surface 28 is reversed and disposed on the position wherein the second surface 29 was disposed, the manifolds 30a, 30b, 31a and 31b correspond to the manifolds 31a, 31b, 30a and 30b, while the manifolds 32a, 32b, 33a and 33b correspond to the manifolds 33a, 33b, 32a and 32b. The manifolds 30a, 30b, 31a and 31b are axially symmetric with the manifolds 32a, 32b, 33a and 33b. In other words, after the first separator 23 is rotated by 90 degrees clockwise around the axis vertical to the first surface 28, the manifolds 30a, 31a, 31b and 31b correspond to the original manifolds 32b, 33a, 32a and 33b.

Moreover, bolt holes 36a, 36b, 36c and 36d are disposed on the unused areas of the first separator 23. Each of the bolt holes 36a, 36b, 36c and 36d is disposed mirror-symmetric and axially symmetric to each other. Accordingly, when the first surface 28 is reversed and disposed on the position wherein the second surface 29 was disposed, the bolt holes 36a, 36b, 36c and 36d correspond to the bolt holes 36c, 36b, 36a and 36d. Accordingly, after the first separator 23 is rotated by 90 degrees clockwise around the axis vertical to the first surface 28, the bolt holes 36a, 36b, 36c and 36d correspond to the original bolt holes 36d, 36a, 36b and 36c.

After the fuel cell stack is completed, each of the bolt holes is penetrated by a bolt so that the fuel cell stack is compressed and fixed with the attachment mechanism of the end plates. The aforesaid mirror-symmetric and axially symmetric arrangements are the keys to effectively combine the first separator and the second separator to form an equivalent bipolar-plate module. The sealing structure and the assembling process will be described hereinafter.

### 2. Second Separator:

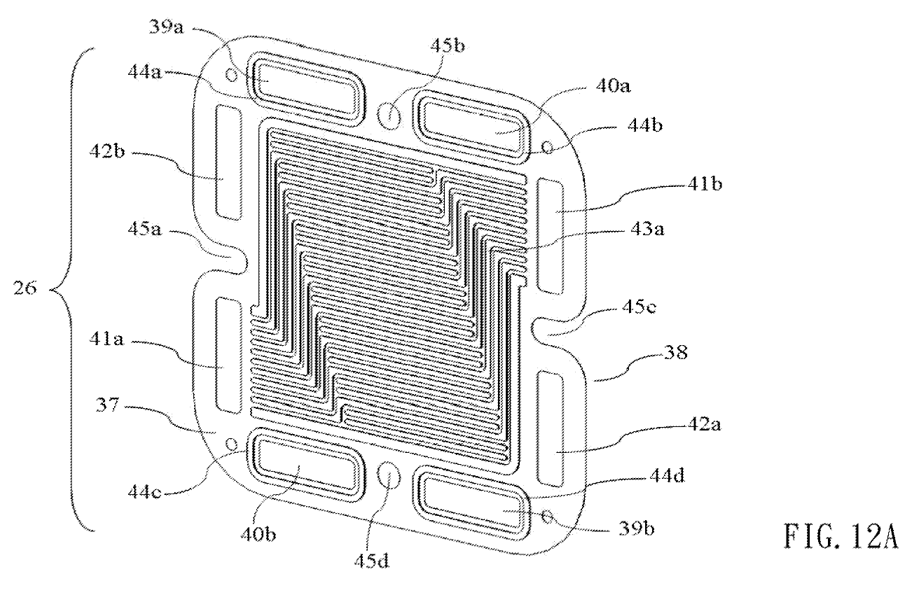

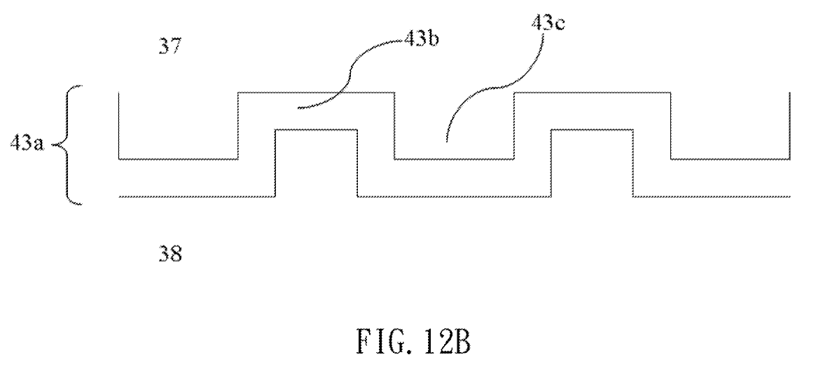

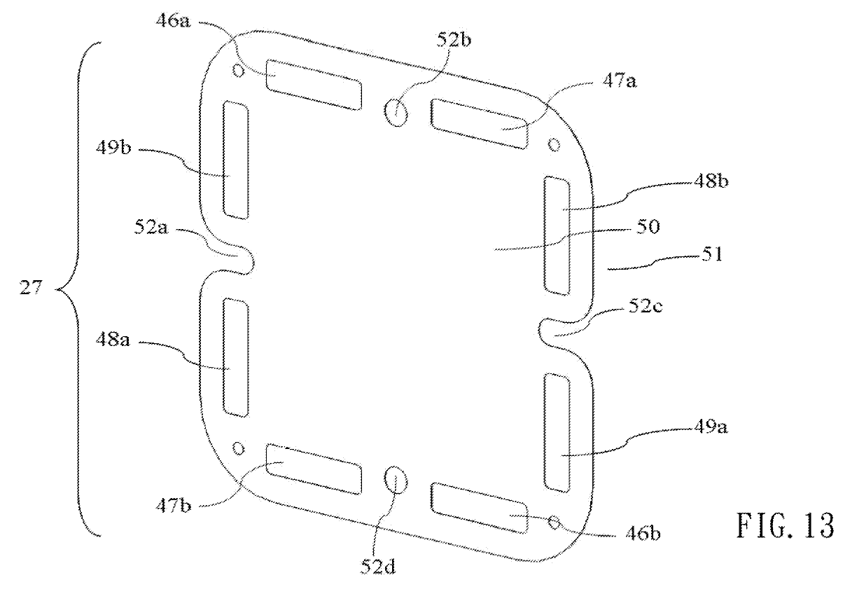

FIG. 12A and FIG. 12B are a 3-D diagram and a cross-sectional diagram of a second separator according to the present invention. The second separator 26 and the first separator 23 are the same separator, while the second separator 26 is formed by rotating the first separator 23 by 90 degrees clockwise around the axis vertical to the first surface 28. The second separator 26 is provided with a first surface 37 and a second surface 38 opposite to the first surface. By the use of the aforesaid mirror-symmetric and axially symmetric arrangements, when the second surface 38 of the second separator 26 is attached to the second surface 29 of the first separator 23 to achieve an equivalent bipolar-plate module, the manifolds 39a, 39b, 40a, 40b, 41a, 41b, 42a and 42b on the second separator 26 correspond to the manifolds 31a, 31b, 30a, 30b, 33a, 33b, 32a, and 32b of the first separator 23.

The coolant flow path 43a comprises alternate ribs 43b and grooves 43c manufactured by stamping. The ribs 43b and the grooves 43c are disposed on the first surface 37 of the second separator 26. Similarly to the first first separator 23, the ribs 43b are capable of transferring a force and are capable of conducting heat and electricity. However, the grooves 43c are used as coolant flow paths. The coolant flow paths are zigzag flow paths. The ribs 44a, 44b, 44c and 44d are formed on the first surface 37 of the second separator 26 and the grooves formed on the second surface 38 correspond to the ribs. With the use of a sealing structure, the second surface 38 of the second separator 26 and the second surface 29 of the first separator 23 are combined to achieve effective sealing. Moreover, the bolt holes 45a, 45b, 45c and 45d on the second separator 26 correspond to the bolt holes 36c, 36b, 36a and 36d on the first separator 23.

### 3. Middle Separator:

FIG. 13 is a 3-D diagram of a middle separator with a planar metal plate according to the present invention. The middle separator 27 is disposed between two second separators 26. Since the ribs 34b on the second separators 26 tightly contact the planar surface of the middle separator 27, grooves 34c as coolant flow paths are formed on the second separator 26 on both sides of the middle separator 27. The manifolds 46a to 49b on the middle separator 27 correspond to the manifolds 39a to 42b on the second separators 26.

The middle separator 27 is provided with the first surface 50 and a second surface 51 opposite to the first surface 50. When the first surface 50 of the middle separator 27 faces the first surface 37 of the second separator 26, manifolds 46a, 46b, 47a, 47b, 48a, 48b, 49a and 49b correspond to the manifolds 40a, 40b, 39a, 39b, 42a, 42b, 41a and 41b of the second separator 26, respectively. When the second surface 51 of the middle separator 27 faces the first surface 37 of the second separator 26, manifolds 46a, 46b, 47a, 47b, 48a, 48b, 49a and 49b correspond to the manifolds 39a, 39b, 40a, 40b, 41a, 41b, 42a and 42b of the second separator 26, respectively.

The bolt holes are disposed similarly to the manifolds. When the first surface 50 of the middle separator 27 faces the first surface 37 of the second separator 26, bolt holes 52a, 52b, 52c and 52d of the middle separator 27 correspond to the bolt holes 45c, 45b, 45a and 45d of the second separator, respectively. When the second surface 51 of the middle separator 27 faces the first surface 37 of the second separator 26, bolt holes 52a, 52b, 52c and 52d of the middle separator 27 correspond to the bolt holes 45c, 45b, 45a and 45d of the second separator, respectively.

### Sealing Structure:

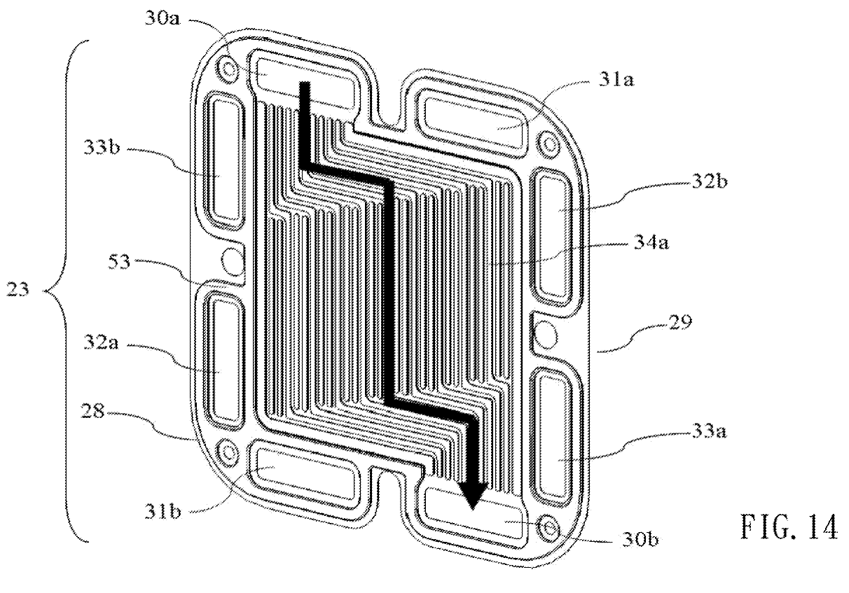

The sealing structure of the present invention comprises membrane electrode assembly sealing members, a coolant sealing member and a separator sealing member, as described in FIG. 14 to FIG. 16, respectively. These sealing members are capable of preventing the reaction gas from leaking or the reaction gas and the coolant from crossing over. Moreover, the membrane electrode assembly sealing members are capable of guiding the fuel and the oxygen-containing gas into the coolant flowing zones. The separator sealing member is the sealing structure for combining the first separator 23 and the second separator 26 as an equivalent bipolar-plate module.

The membrane electrode assembly sealing members, the coolant sealing member and the separator sealing member will be described in detail hereinafter.

### 1. Membrane Electrode Assembly Sealing Member:

FIG. 14 is a combinational schematic diagram of a membrane electrode assembly sealing member and a first separator according to the present invention. The membrane electrode assembly sealing member 53 is attached to the first surface 28 of the first separator 23 by an adhesive or by injection molding on the metal plate. The membrane electrode assembly sealing member 53 comprises a compressible material such as silicone and has a thickness matching the thickness of the gas diffusion layers and the membrane electrode assembly. The membrane electrode assembly sealing member 53 is an integrated sealing structure to entirely surround manifolds 31a, 31b, 32a, 32b, 33a and 33b and partly surround manifolds 30a and 30b with an opening facing the reaction gas flow paths 34a. By combining the membrane electrode assembly sealing member 53 and the first separator 23, the gas diffusion layer and the membrane electrode assembly can be clipped to form a cathode side and an anode side. By pressing the membrane electrode assembly sealing member on both the cathode side and the anode side against each other, leakage and cross-over between the reaction gases or between the reaction gas and the coolant can be prevented. Moreover, the membrane electrode assembly sealing member is capable of guiding the reaction gas into the reaction gas flowing zone 34a by way of the manifold 30a and out of the fuel cell stack by way of the manifold 30b, as denoted by the arrow.

### 2. Coolant Sealing Member:

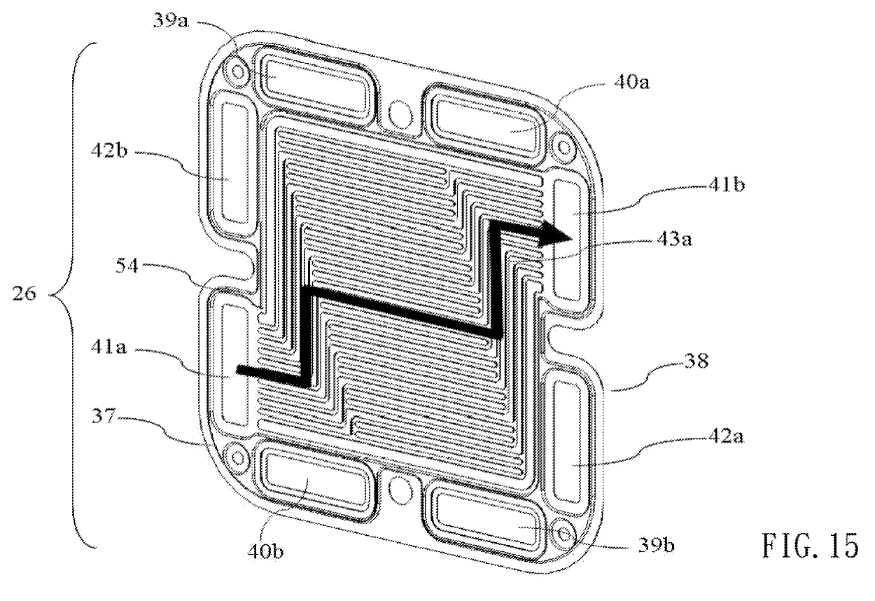

FIG. 15 is a combinational schematic diagram of a coolant sealing member and a second separator according to the present invention. The coolant sealing member 54 is attached to the first surface 37 of the second separator 26 by an adhesive or by injection molding on the metal plate. The coolant sealing member 54 comprises a compressible material such as silicone and has a height matching the height of the ribs 43b on the coolant flow path 43a. The coolant sealing member 54 is an integrated sealing structure to entirely surround manifolds 39a, 39b, 40a, 40b, 42a and 42b and partly surround manifolds 41a and 41b with an opening facing the reaction gas flow paths 43a. By combining the coolant sealing member 54 and the second separator 26, the middle separator 27 can be clipped to form coolant flow paths on both sides of the middle separator 27. By pressing coolant sealing members 54 on both sides of the middle separator 27, leakage and cross-over between the reaction gases or between the reaction gas and the coolant can be prevented. Moreover, the coolant is guided into the coolant flowing zone 43a by way of the manifold 41a and out of the fuel cell stack by way of the manifold 41b, as denoted by the arrow.

### 3. Separator Sealing Member:

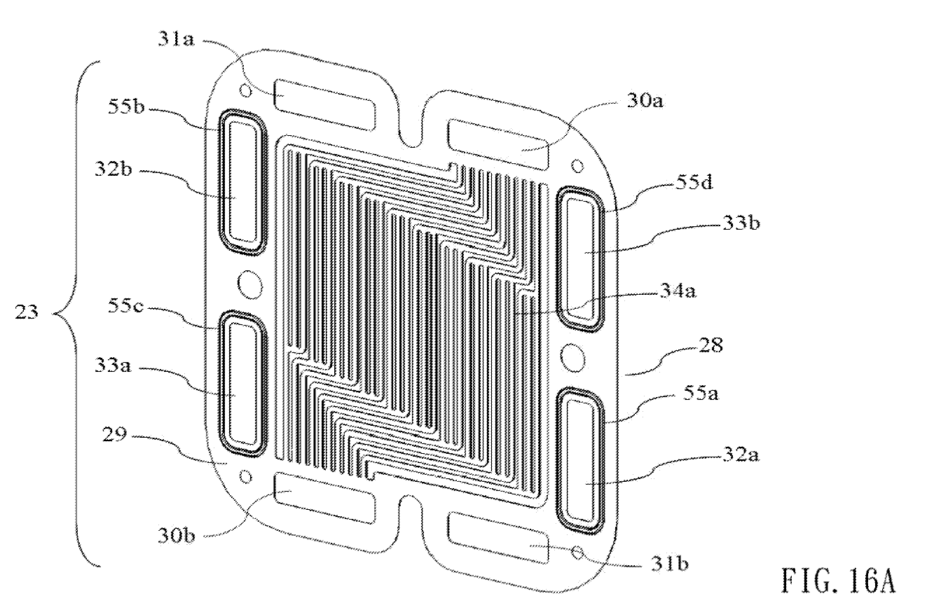

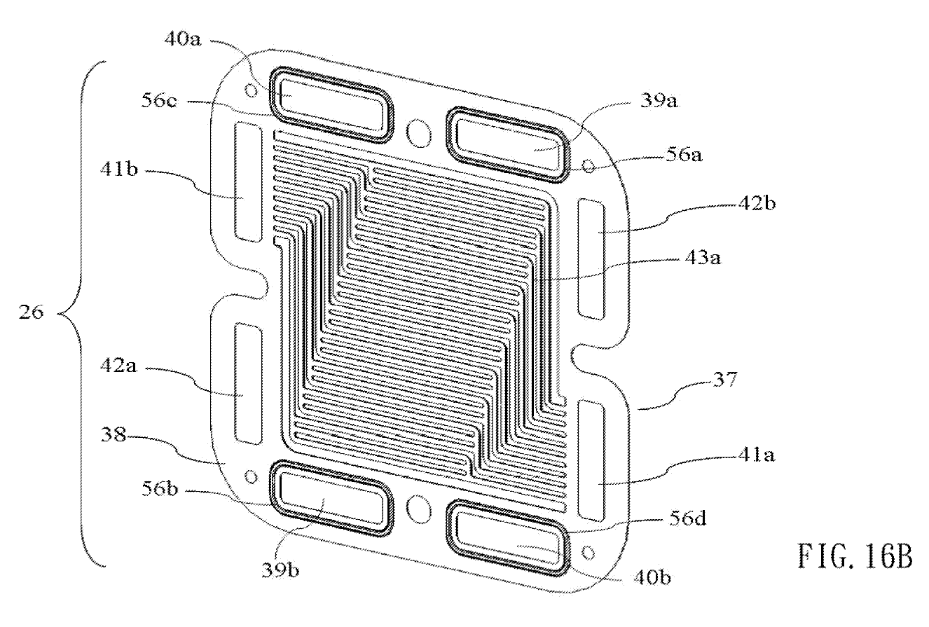

FIG. 16A and FIG. 16B are a combinational schematic diagrams of a separator sealing member and a first separator and a combinational schematic diagram of a separator sealing member and a second separator according to the present invention. On the first separator 23, the separator sealing members 55a to 55d are disposed in the grooves on the second surface 29 of the first separator 23 by an adhesive or by injection molding on the metal plate. The grooves are those on the second surface 29 that correspond to the ribs 35a, 35b, 35c and 35d formed on the first surface 28 of the first separator. Similarly, on the second separator 26, the separator sealing members 56a to 56d are disposed in the grooves on the second surface 38 of the second separator 26 by an adhesive or by injection molding on the metal plate. The grooves are those on the second surface 38 that correspond to the ribs 44a, 44b, 44c and 44d formed on the first surface 37 of the second separator. The separator sealing members 55a to 55d and 56a to 56d have the same structure. They comprise a compressible material such as silicone and have a height matching the depth of the grooves.

By the aforesaid mirror-symmetric and axially symmetric arrangements, when the second surface 29 of the first separator 23 is attached to the second surface 38 of the second separator 26 to form an equivalent bipolar-plate module, the separator sealing members 55a to 55d surround the manifolds 32a, 32b, 33a and 33b on the first separator 23 and the manifolds 42a, 42b, 41a and 41b on the second separator 26. The separator sealing members 56a to 56d surround the manifolds 39a, 39b, 40a and 40b on the second separator 26 and the manifolds 31a, 31b, 30a and 30b on the first separator 23. Since the first separator 23 and the second separator 26 are pressed against each other, the compressed separator sealing members 55a to 55d and 56a to 56d are capable of preventing leakage and cross-over between the reaction gases or between the reaction gas and the coolant.

### Assembling Process:

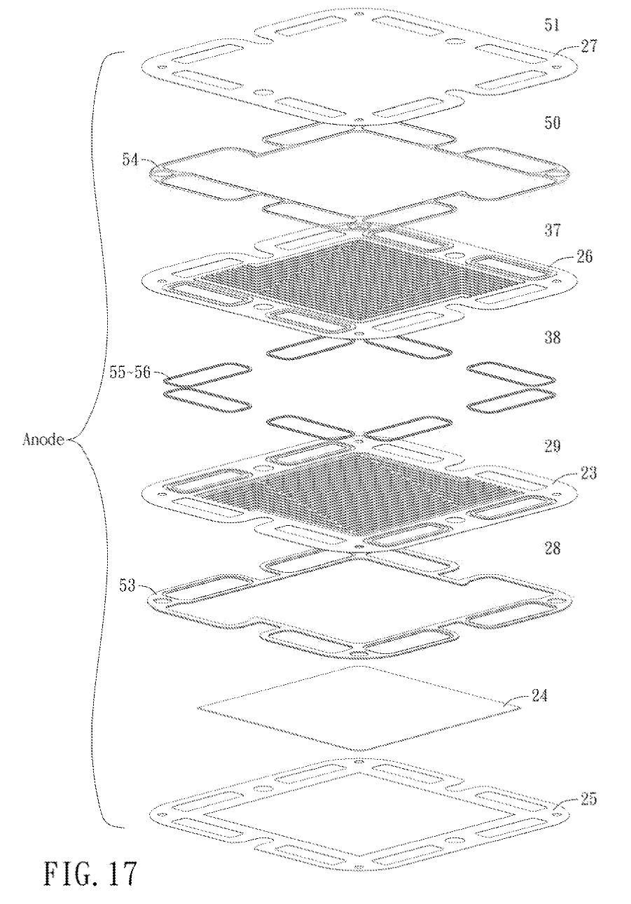

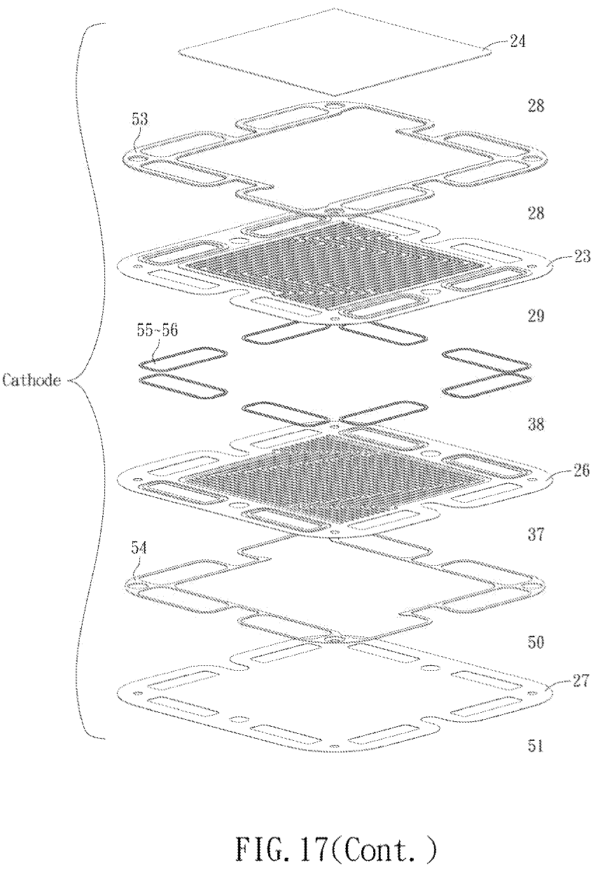

FIG. 17 is an exploded view of a single cell structure according to the present invention. On the cathode side of the fuel cell stack, the first surfaces 28 of the first separator 23 is combined with the membrane electrode assembly sealing member 53 and the ribs on the first surface 28 contact the cathode gas diffusion layer 24. A membrane electrode assembly 25 is disposed between the gas diffusion layers 24. Then, the second surface 29 of the first separator 23 is combined with the second surface 38 of the second separator 26. The separator sealing members 55 to 56 are disposed in the grooves between the first separator 23 and the second separator 26. Finally, the first surface 37 of the second separator 26 is attached to the coolant sealing members 54 so that the ribs on the first surface 37 contact the first surface 50 of the middle separator 27. A half cell can be formed on the cathode side accordingly. Similarly, a half cell can also be formed on the anode side. By combining the half cell on the cathode side and the half cell on the anode side, a single cell structure can be formed.

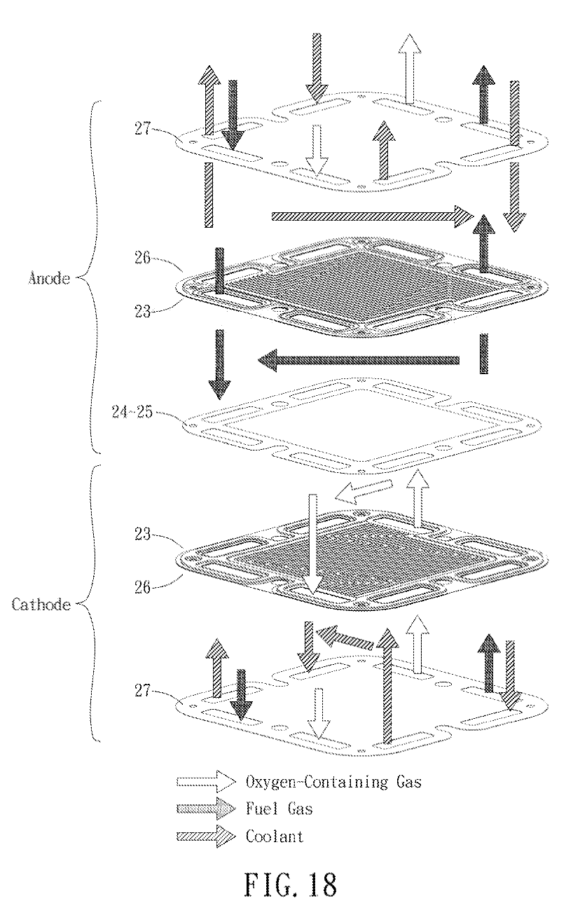

FIG. 18 shows a flow field through a single cell structure according to the present invention. The oxygen-containing gas is guided into the oxygen-containing gas flow paths on the first separator 23 by way of the oxygen-containing gas supply manifold on the middle separator 27, the second separator 26 and the first separator 23. The oxygen-containing gas in the flow paths diffuses into the reaction zones 24 to 25 to cause the reduction reaction on the cathode side. The unused oxygen-containing gas and produced water enter the oxygen-containing gas discharge manifold from the flow paths and are discharged out of the fuel cell stack. The fuel gas is guided into the fuel gas flow paths on the first separator 23 by way of the fuel gas supply manifold on the middle separator 27, the second separator 26 and the first separator 23. The fuel gas in the flow paths diffuses into the reaction zones 24 to 25 to cause the oxidation reaction on the anode side. The unused fuel gas enters the fuel gas discharge manifold from the flow paths and is discharged out of the fuel cell stack. The coolant is guided into the coolant flow paths between the second separator 26 and the middle separator 27 by way of the coolant supply manifolds on the middle separator 27 and the second separator 26. The fuel gas in the flow paths diffuses into the reaction zones 24 to 25 to cause the oxidation reaction on the anode side. The unused fuel gas enters the fuel gas discharge manifold from the flow paths and is discharged out of the fuel cell stack. The coolant absorbs the waste heat during power generation in the fuel cell stack. Then, the coolant with rising temperature flows into the coolant discharge manifold from the flow paths and then is discharged out of the fuel cell stack.

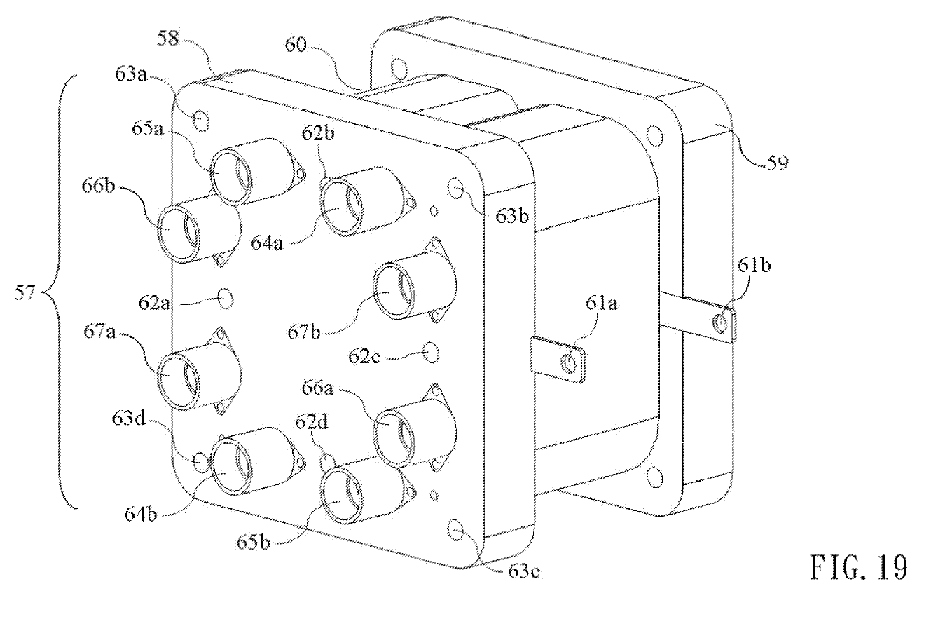

FIG. 19 is a schematic diagram of a fuel cell stack according to the present invention. To form the fuel cell stack 57, an open-end plate 58 and a closed-end plate 59 are required to clip a plurality of single cell structures 60. A cathode current collector 61a and an anode current collector 61b are disposed between the two end plates and the plurality single cell structures and are used as current paths comprising external circuitry. The bolt holes 62a to 62d penetrate the open-end plate 58 and the closed-end plate 59 and correspond to the bolt holes on the separators. Moreover, the bolt holes 63a to 63d also penetrate the open-end plate 58 and the closed-end plate 59. The bolt holes 63a to 63d and 62a to 62d are all penetrated by bolts. Moreover, the surfaces of the open-end plate 58 and the closed-end plate 59 have to be electrically insulating to make sure that the current can enter the current collectors. Therefore, the end plates can be manufactured using an insulating material with proper structural strength. Alternatively, the end plates can also be manufactured using metal as an end plate body, which is then performed with an insulating treatment thereon.

By compressing the fuel cell stack 57, the force is transferred through the open-end plate 58 and the closed-end plate 59 to a plurality of single cell structures 60. The force is also transferred through the ribs on the separators to the gas diffusion layers and the membrane electrode assembly so that the compressed deformation ensures the contact. The force transferred through the ribs can also ensure that the separators tightly contact each other. Moreover, the compressed deformation is also generated by compressing the sealing structure to effectively seal the reaction gas and the coolant to prevent leaking and crossing over. Finally, as the fuel cell stack 57 is compressed to exhibit an optimal height, the bolts in the bolt holes 62a to 62d and 63a to 63d are fixedly disposed on the end plates by an attachment mechanism. Accordingly, a fuel cell stack is assembled and fixed.

To guide the reaction gas and the coolant into the supply manifolds on the separator and out of the discharge manifold on the separator, a supply channel 64a and a discharge channel 64b for the oxygen-containing gas, a supply channel 65a and a discharge channel 65b for the fuel gas, and supply channels 66a and 67a and discharge channels 66b and 67b for the coolant are provided on the open-end plate 58. These channels and the aforesaid manifolds are used as a flow field network for the oxygen-containing gas, the fuel gas and the coolant so as to supply sufficient reaction gas and coolant and discharge the unused gas, the produced water and the waste heat. By compressing and fixing the aforesaid fuel cell stack and combining the channels 64a to 67b and the open-end plate 58, the assembling process for a fuel cell stack is completed.

According to the above discussion, it is apparent that the present invention discloses a single cell structure used in a fuel cell stack with metal separators and a method thereof. Therefore, the present invention is useful, novel and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A single cell structure used in a fuel cell stack with metal separators, the single cell structure comprising:
a cathode gas diffusion layer;
an anode gas diffusion layer;
a membrane electrode assembly, disposed between the cathode gas diffusion layer and the anode gas diffusion layer;
a pair of first separators disposed outside the cathode gas diffusion layer and the anode gas diffusion layer, a first surface of the first separators being provided with a plurality of grooves and ribs thereon, wherein the grooves are used as flow paths for fuel and oxygen-containing gas, while the ribs are capable of transmitting forces and conducting heat and electricity;
a pair of second separators disposed outside the first separators to be assembled with the first separators, a first surface of the second separators being provided with a plurality of groove and ribs, wherein the grooves are used as coolant flow paths, while the ribs are capable of transmitting forces and conducting heat and electricity; and
a pair of middle separators disposed outside the second separators to be assembled with the second separators, wherein both sides of the middle separators are provided with the coolant flow paths in the grooves on the second separators.

2. The single cell structure used in a fuel cell stack with metal separators as recited in claim 1, wherein the first separators are metal plates formed by stamping.

3. The single cell structure used in a fuel cell stack with metal separators as recited in claim 1, wherein the first separators are provided with a reaction gas supply manifold and a reaction gas discharge manifold being mirror-symmetric, and a coolant supply manifold and a coolant discharge manifold being mirror-symmetric, while the reaction gas supply and discharge manifolds and the coolant supply and discharge manifolds are axially symmetric.

4. The single cell structure used in a fuel cell stack with metal separators as recited in claim 1, wherein a flow field formed by the grooves on the first separators for fuel or oxygen-containing gas is straight, regularly or irregularly arc-shaped or zigzag.

5. The single cell structure used in a fuel cell stack with metal separators as recited in claim 1, wherein the first surface of the first separators is provided with the ribs surrounding coolant manifolds thereon and a second surface is provided with the grooves thereon corresponding to the ribs, the grooves forming a space to accommodate a sealing structure.

6. The single cell structure used in a fuel cell stack with metal separators as recited in claim 1, wherein the first separators are provided with a plurality of mirror-symmetric and axially symmetric bolt holes.

7. The single cell structure used in a fuel cell stack with metal separators as recited in claim 1, wherein the second separators and first separators have the same structure and the second separators are formed by rotating the first separators by 90 degrees clockwise with respect to a central axis on the first surface of the first separators.

8. The single cell structure used in a fuel cell stack with metal separators as recited in claim 1, wherein the middle separators are metal plates formed by stamping and are provided with reaction gas manifolds and coolant manifolds and a plurality of bolt holes.

9. The single cell structure used in a fuel cell stack with metal separators as recited in claim 1, further comprising:
an anode membrane electrode assembly sealing member disposed on the first separators;
a cathode membrane electrode assembly sealing member disposed on the first separators;
a coolant sealing member disposed between the second separators and the middle separators; and
a plurality of separator sealing members disposed between the first separators and the second separators.

10. The single cell structure used in a fuel cell stack with metal separators as recited in claim 9, wherein the membrane electrode assembly sealing members are combined with the first surface of the first separators by an adhesive or by injection molding on the metal plates, the membrane electrode assembly sealing members comprising a compressible material and having a thickness matching the thickness of the gas diffusion layers and the membrane electrode assembly.

11. The single cell structure used in a fuel cell stack with metal separators as recited in claim 9, wherein the membrane electrode assembly sealing member is an integrated sealing structure with an opening facing the reaction gas flow path while surrounding the other manifolds.

12. The single cell structure used in a fuel cell stack with metal separators as recited in claim 9, wherein the coolant sealing member is combined with the first surface of the second separators by an adhesive or by injection molding on the metal plates, the coolant sealing member comprising a compressible material and having a thickness matching the height of the ribs in the coolant flow path on the second separators.

13. The single cell structure used in a fuel cell stack with metal separators as recited in claim 9, wherein the coolant sealing member is an integrated sealing structure with an opening facing the coolant flow path while surrounding the other manifolds.

14. The single cell structure used in a fuel cell stack with metal separators as recited in claim 9, wherein the separator sealing member is combined with the second surface of the first separators or the second surface of the second separators by an adhesive or by injection molding on the metal plates, the separator sealing member being disposed in the grooves on the first separators or the second separators and comprising a compressible material and having a height matching the depth of the grooves.

15. A fuel cell stack with metal separators, the fuel cell stack comprising a plurality of single cell structures being stacked, an anode current collector, a cathode current collector, an open-end plate and a closed-end plate, wherein:
each of the single cell structures comprises: a cathode gas diffusion layer; an anode gas diffusion layer; a membrane electrode assembly, disposed between the cathode gas diffusion layer and the anode gas diffusion layer; a pair of first separators disposed outside the cathode gas diffusion layer and the anode gas diffusion layer; a pair of second separators forming coolant flow paths; a pair of middle separators; an anode membrane electrode assembly sealing member disposed on the first separators; a cathode membrane electrode assembly sealing member disposed on the first separators; a coolant sealing member disposed between the second separators and middle separators; and a plurality of separator sealing member disposed between the first separators and the second separators;
the anode current collector and the cathode current collector are disposed between the plurality of single cell structures and the open-end and closed-end plates; and
the open-end and closed-end plates are disposed outside the plurality of single cell structures and the current collectors.

16. The fuel cell stack with metal separators as recited in claim 15, wherein the open-end plate and the closed-end plate are provided with a plurality of bolt holes corresponding to bolt holes on the separators.

17. The fuel cell stack with metal separators as recited in claim 15, wherein the open-end plate and the closed-end plate are electrically insulating on the surface.

18. The fuel cell stack with metal separators as recited in claim 15, wherein the open-end plate is provided with supply manifolds and discharge manifolds for fuel, oxygen-containing gas, and coolant.

19. An assembling method for a single cell structure used in a fuel cell stack with metal separators, comprising steps of:
combining a first surface of a first separator and a cathode membrane electrode assembly sealing member, and combining a first surface of another first separator and an anode membrane electrode assembly sealing member;
connecting ribs on the first surface of the first separator to a cathode gas diffusion layer, and connecting ribs on the first surface of another first separator to an anode gas diffusion layer;
disposing a membrane electrode assembly between the cathode gas diffusion layer and an anode gas diffusion layer;
combining grooves on a second surface of the first separator and a plurality of separator sealing members, and combining grooves on a second surface of another first separator and a plurality of separator sealing members;
combining grooves on a second surface of a second separator and a plurality of separator sealing members, and combining grooves on a second surface of another second separator and a plurality of separator sealing members;
combining the second surface of the first separator and the second surface of the second separator, and combining the second surface of another first separator and the second surface of another second surface;
combining a first surface of the second separator and a coolant sealing member, and combining a first surface of another second separator and another coolant sealing member; and
connecting ribs on the first surface of the second separator to a first surface of a middle separator, and connecting ribs on the first surface of another second separator to a first surface of another middle separator. x
